(19) United States
(12) Patent Application Publication
(10) Pub. No.: US 2013/0279105 A1
(43) Pub. Date: Oct. 24, 2013

(54) INTERFACE DEVICE AND SERVER EMPLOYING SAME

(71) Applicants: Zheng-Heng SUN, Tu-Cheng (TW); An-Gang LIANG, Shenzhen City (CN)

(72) Inventors: Zheng-Heng SUN, Tu-Cheng (TW); An-Gang LIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/628,471

(22) Filed: Sep. 27, 2012

(30) Foreign Application Priority Data
Apr. 23, 2012 (CN) 201210119718.3

(51) Int. Cl. G06F 1/16

(52) U.S. Cl. 361/679.4

(57) ABSTRACT

An interface device includes a circuit assembly, a fastening member having the circuit assembly accommodated and fastened inside; and a housing receiving the fastening member assembled inside. The fastening member removably secures the interface device to a periphery of a server. A server employing the present interface device is also described.

### BACKGROUND

1. Technical Field

The present disclosure relates to interface devices, and particularly to an interface device for servers and a server employing the interface device.

2. Description of Related Art

Servers usually have multiple interfaces, such as networking interfaces and audio and video interfaces, and universal serial bus (USB) interfaces. In use, cables are inserted into the interfaces to transfer data in and out of the servers. For example, when a se er needs to connect to a network, one end of the network cable connects with the networking interface of the server, with the other end of the network cable extending out of a frame of the server. However, because the networking interfaces are usually located at the middle position inside the servers, long network cables are employed and are usually bent at a right-angle. Moreover, the network cables extending from the inside of the server may block a radiator outlet of the server, thus reducing a radiating efficiency of the server.

Therefore, there is room for improvement within the art.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawing like reference numerals designate corresponding parts throughout the views.

FIG. 1 is an isometric view of an interface device assembled to a server in accordance with a first exemplary embodiment.

FIG. 2 is an isometric view of the interface device of FIG. 1.

FIG. 3 is an exploded view of the interface device of FIG. 2.

FIG. 4 is an exploded view of the interface device of FIG. 2 viewed from another angle.

FIG. 5 is an isometric view of a fastening member of an interface device in accordance with a second exemplary embodiment.

FIG. 6 is an isometric view of an interface device assembled to a server in accordance with the second exemplary embodiment.

### DETAILED DESCRIPTION

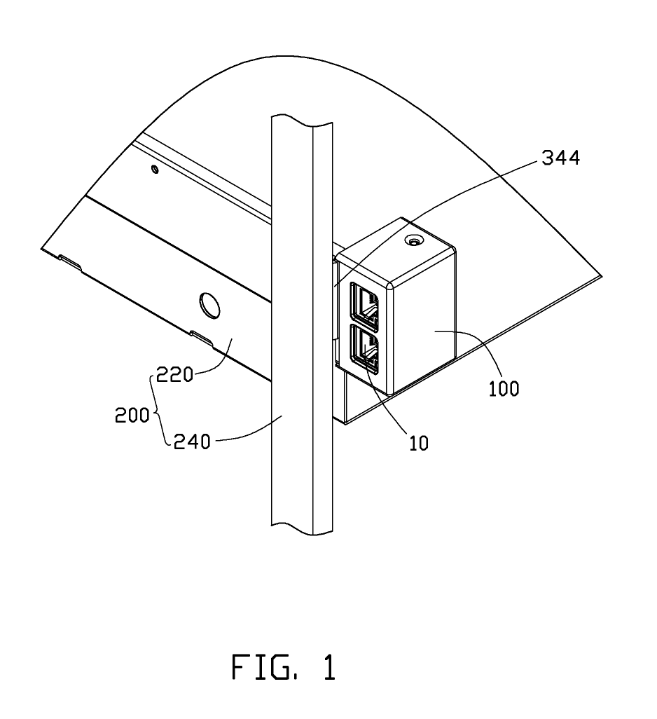

FIG. 1 shows a first exemplary embodiment of an interface device 100 assembled to a server 200. The server 200 includes a server body 220 and a frame 240. The interface device 100 is mounted to the server body 220. The server body 220 is fastened to the frame 240.

The interface device 100 may be a networking interface, an audio and video interface, or a USB interface. In the exemplary embodiment, the interface device 100 is a networking interface.

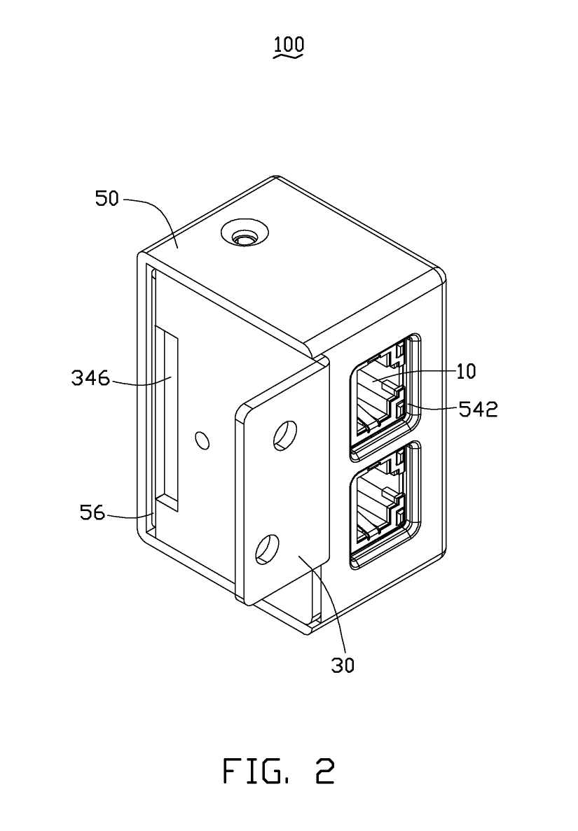

Referring to FIG. 2, the interface device 100 includes a circuit assembly 10, a fastening member 30, and a housing 50. The circuit assembly 10 is positioned within the fastening member 30. The fastening member 30 is assembled to the housing 50.

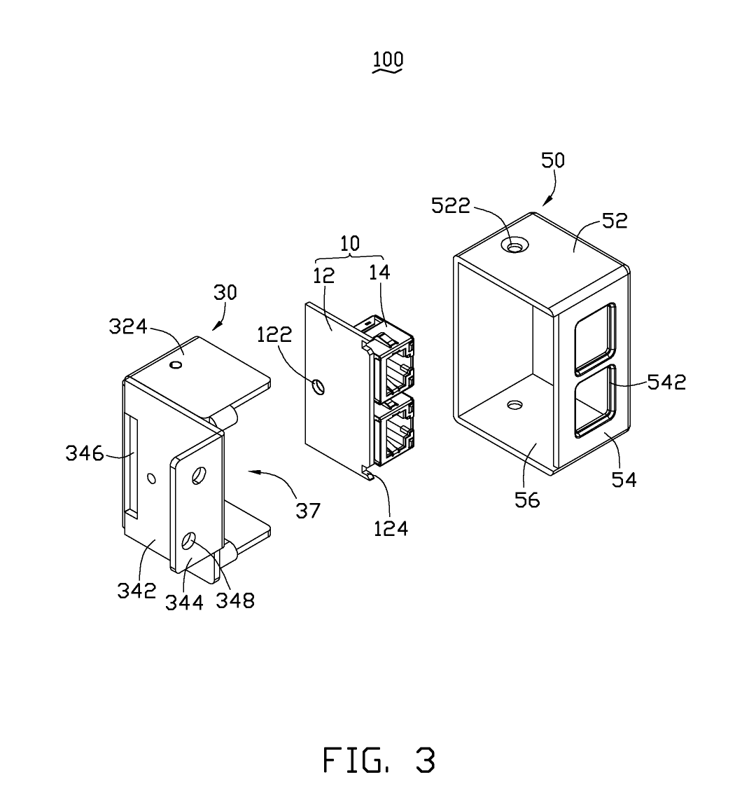

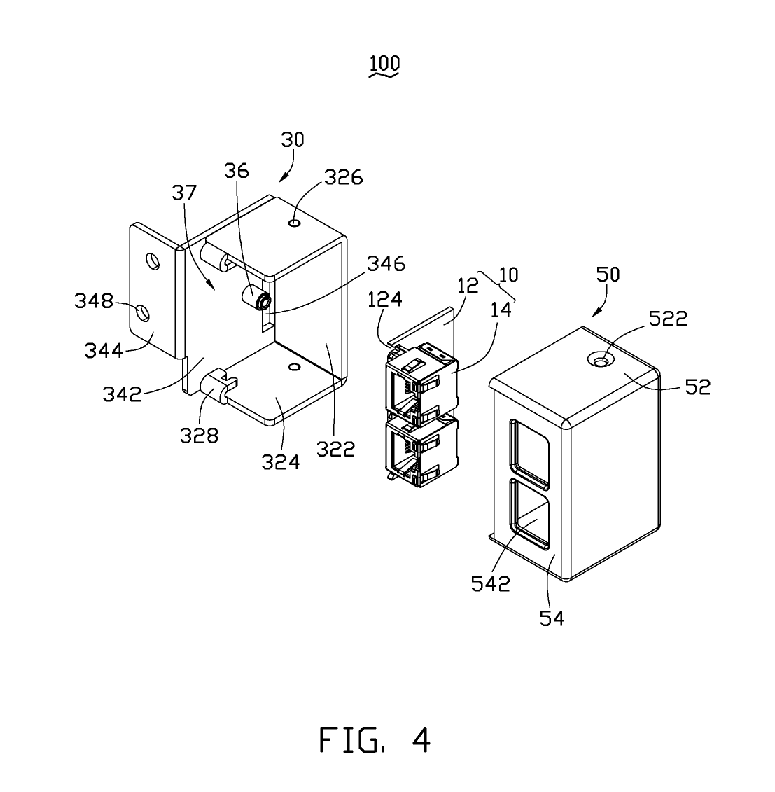

Referring to FIGS. 3 and 4, the circuit assembly 10 includes a circuit board 12 and at least one connector 14 attached to the circuit board 12. The circuit board 12 defines a first through hole 122 and defines two notches 124 through an edge portion thereof. In the exemplary embodiment, the circuit assembly 10 has two connectors 14. The two connectors 14 are network connectors. The two connectors 14 are secured on and conductively connected to the circuit board 12.

The fastening member 30 accommodates and fastens the circuit assembly 10 therein. The fastening member 30 includes a sidewall 322, two end wall 324, a back wall 342, and a tab 344. The sidewall 322, the end walls 324, the back wall 342, and the tab 344 may be integrally formed together.

The end walls 324 are opposite to each other and connect with two opposite ends of the sidewall 322, respectively. Each end wall 324 defines a first assembling hole 326 and has a clasp 328 extending from an end away from the sidewall 322 and bending towards the sidewall 322. The clasps 328 are opposite to each other. The clasps 328 engage in the notches 124 of the circuit board 12 to secure the circuit board 12 between the end walls 324.

The back wall 342 has two ends connecting with the two end walls 324, respectively, and an edge portion connecting with the sidewall 322, thereby the back wall 342, the end walls 324, and the sidewall 322 cooperatively forming a receiving space 37 for receiving the circuit assembly 10. The back wall 342 defines a post 36 and a second through hole 346. The post 36 protrudes from the back wall 342 and extends toward the receiving space 37. In assembly, the post 36 extends through the first through hole 122 of the circuit board 12 and engages with a screw nut (not shown) to further secure the circuit assembly 10. The second through hole 346 is defined in a portion of the post 36 close to the sidewall 322, facilitating wires (not shown) extending through the second through hole 346 to conductively connect the circuit assembly 10 and a main board of the server 200. The tab 344 extends substantially perpendicularly from an edge portion of the back wall 342 away from the sidewall 322 and extends along a direction away from the receiving space 37. The tab 344 defines at least one securing hole 348 for removably securing the fastening member 30 on the server body 220 by a screw screwed therein, for example.

The housing 50 is substantially a rectangular box having an open end 56. The housing 50 includes two securing boards 52 opposite to each other and three side boards 54 connecting with and located between the securing boards 52. Each securing board 52 defines a second assembling hole 522 in a position corresponding to the first assembling hole 326. The first assembling holes 326 and the second assembling holes 522 are used for assembling the housing 50 to the fastening member 30 by screws. One of the securing boards 52 defines at least one opening 542 corresponding to the at least one connector 14. In the exemplary embodiment, two openings 542 are defined in one of the securing boards 52. When the fastening member 30 and the circuit assembly 10 are assembled inside the housing 50, the at least one connector 14 of the circuit assembly 10 is exposed from the at least one opening 542; the second through hole 346 of the fastening member 30 is exposed from the open end 56.

Referring to FIGS. 1-4, to assemble the interface device 100, the circuit assembly 10 is positioned in the receiving space 37 of the fastening member 30, with the clasps 328 engaging in the notches 124 of the circuit board 12 and the post 36 engaging in the first through hole 122. Then, the fastening member 30 receiving the circuit assembly 10 is positioned in the housing 50 through the open end 56, with the at least one connector 14 exposed from the at least one opening 542, the second through hole 346 exposed from the open end 56, and the first assembling holes 326 aligned with the second assembling holes 522. Screws are screwed into the first assembling holes 326 and the second assembling holes 522. The tab 344 of the fastening member 30 is fastened to a sidewall of the server body 220. The server body 220 is mounted to the frame 240 with the at least one connector 14 located near the frame 240 and facing outside of the frame 240. Thus, when connecting network cables to the at least one connectors 14, the network cables extend only a short distance from the outside to reach the at least one connector 14 and do not need to be bent. Moreover, short network cables do not block a radiator outlet of the server 200.

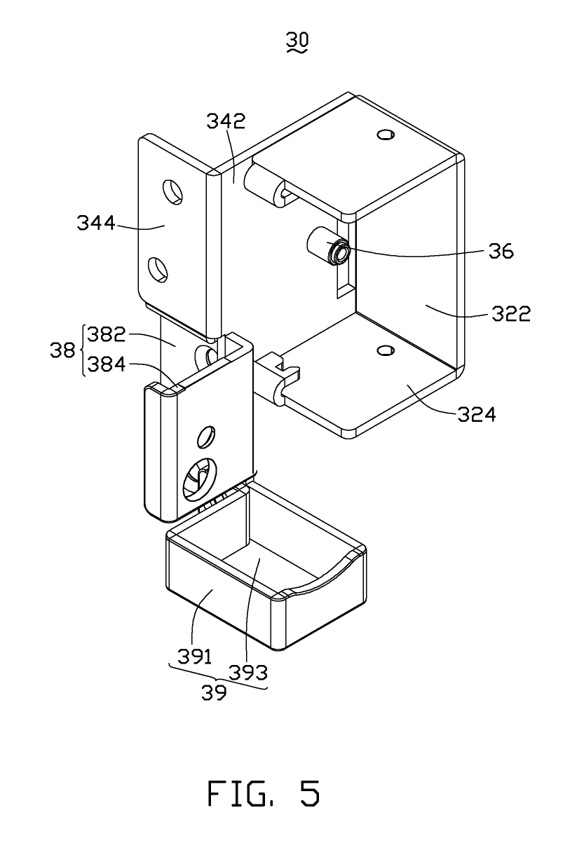

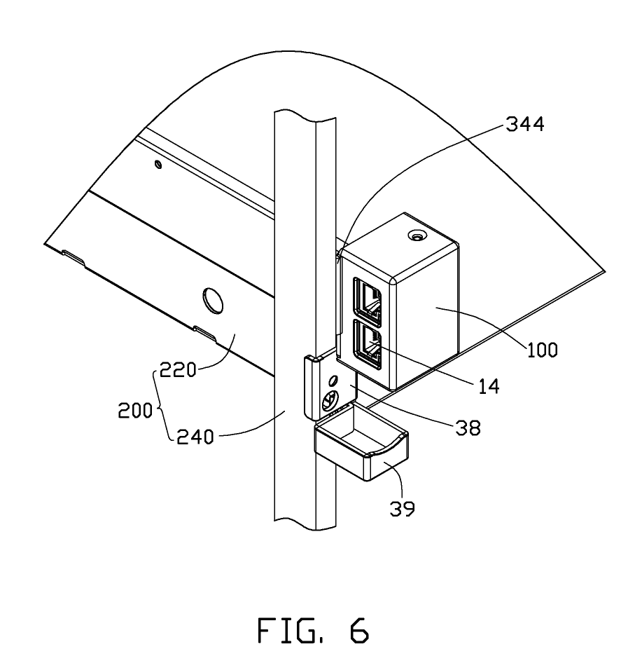

FIGS. 5 and 6 show a second exemplary embodiment of an interface device 100. Unlike the first embodiment, the fastening member 30 of the second exemplary embodiment further includes an assembling board 38 and an operation portion 39. The assembling board 38 is substantially L-shaped and includes a first portion 382 and a second portion 384. The first portion 382 connects with a lower end of the tab 344 and is substantially parallel to the tab 344. The second portion 384 extends perpendicularly from an end of the first portion 382 and is substantially parallel to the back wall 342. The assembling board 38 secures the fastening member 30 to the frame 240 by screws. Thus, the interface device 100 is further secured to the frame 240. Accordingly, the interface device 100, the server body 220, and the frame 240 can be assembled together by the fastening member 30 further including the assembling board 38, without any additional assembling mechanism for assembling the server body 220 and the frame 240 required.

The operation portion 39 connects with a lower end of the second portion 384. The operation portion 39 includes a peripheral wall 391 and an operation space 393 surrounded by the peripheral wall 391. The operation space 39 is used for separating the server body 220 from the frame 240 by putting a finger in the operation space 393 and pulling the operation portion 39. When it is required to separate the server body 220 from the frame 240 for some purpose, such as inspection or repair, finger pulling the operation portion can easily separate the entire server body 220 from the frame 240 under the condition that the assembling board and the frame being disassembled.

It should be understood, that one of the clasp 328 and post 36 can be omitted if the circuit assembly 10 can be tightly secured in the fastening member 30 without the clasp 328 or the post 36.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An interface device, comprising:
a circuit assembly;
a fastening member having the circuit assembly accommodated and fastened therein; and
a housing having the fastening member assembled therein, the fastening member removably securing the interface device to a periphery of a server.

2. The interface device as claimed in claim 1, wherein the housing defines at least one opening; the circuit assembly includes at least one connector; the at least one connector is exposed from the at least one opening.

3. The interface device as claimed in claim 1, wherein the fastening member includes a sidewall, two end wall, and a back wall; the end walls are opposite to each other and connect with two opposite ends of the sidewall; the back wall connects with the two end walls and the sidewall, thereby the back wall, the end walls, and the sidewall cooperatively forming a receiving space for receiving the circuit assembly.

4. The interface device as claimed in claim 3, wherein each of the end walls has a clasp extending from an end away from the sidewall and bending towards the sided wall; the circuit assembly includes a circuit board defining two notches through an edge portion of the circuit board; the clasps engage in the notches.

5. The interface device as claimed in claim 4, wherein the circuit board defines a first through hole; the back wall defines a post extending in the receiving space; the post engages in the first through hole.

6. The interface device as claimed in claim 3, wherein the fastening member further includes a tab; the tab extends substantially perpendicularly from an edge portion of the back wall away from the sidewall and extends along a direction away form the receiving space.

7. The interface device as claimed in claim 6, wherein the fastening member removably secures the interface device to the server through the tab.

8. A server, comprising:
a server body; and
an interface device, the interface including:
a circuit assembly;
a fastening member having the circuit assembly accommodated and fastened inside; and
a housing having the fastening member assembled inside, the fastening member removably securing the interface device to a periphery of a server.

9. The server as claimed in claim 8, wherein the fastening member includes a sidewall, two end wall, and a back wall; the end walls are opposite to each other and connect with two opposite ends of the sidewall; the back wall connects with the two end walls and the sidewall, thereby the back wall, the end walls, and the sidewall cooperatively forming a receiving space for receiving the circuit assembly.

10. The server as claimed in claim 9, wherein the fastening member further includes a tab; the tab extends substantially perpendicularly from an edge portion of the back wall away from the sidewall and extends along a direction away form the receiving space; the fastening member removably secures the interface device to the server through the tab.

11. The server as claimed in claim 10, further comprising a frame; the fastening member further includes an assembling board; the assembling board is secured to the frame.

12. The server as claimed in claim 11, wherein the assembling board includes a first portion and a second portion; the first portion connects with a lower end of the tab and is substantially parallel to the tab; the second portion extends perpendicularly from an end of the first portion and is substantially parallel to the back wall.

13. The server as claimed in claim 11, the fastening member further includes an operation portion connecting with assembling board; the operation portion includes a peripheral wall and an operation space surrounded by the peripheral wall.

14. The server as claimed in claim 9, wherein each of the end walls has a clasp extending from an end away from the sidewall and bending towards the sided wall; the circuit assembly includes a circuit board defining two notches through an edge portion of the circuit board; the clasps engage in the notches.

15. The server as claimed in claim 14, wherein the circuit board defines a first through hole; the back wall defines a post extending in the receiving space; the post engages in the first through hole.

16. The server as claimed in claim 8, wherein the housing defines at least one opening; the circuit assembly includes at least one connector; the at least one connector is exposed from the at least one opening.
